(19) United States
(12) Patent Application Publication
(10) Pub. No.: US 2025/0237509 A1
(43) Pub. Date: Jul. 24, 2025

(54) SYSTEM FOR GUIDING A USER VIA AN AUDIO SIGNAL, AND CORRESPONDING GUIDING METHOD

(71) Applicants: RUNBLIND, PALAISEAU (FR); ECOLE POLYTECHNIQUE, PALAISEAU (FR); CENTRE NATIONAL DE LA RECHERCHE SCIENTIFIQUE, PARIS (FR)

(72) Inventors: Philippe LE BORGNE, PARIS (FR); François ALOUGES, LE PLESSIS-ROBINSON (FR); Sylvain FERRAND, BREUILLET (FR)

(21) Appl. No.: 18/700,157

(22) PCT Filed: Oct. 13, 2022
(86) PCT No.: PCT/EP2022/078572

§ 371 Date: Apr. 10, 2024

(30) Foreign Application Priority Data
Oct. 15, 2021 (FR) 2110987

(51) Int. Cl. G01C 21/20; H04R 5/033

(52) U.S. Cl. CPC G01C 21/20; H04R 5/033; H04R 2205/024

(57) ABSTRACT

A system for guiding a user, comprising a portable computer terminal and a stereophonic audio device that is associated with the head of the user, the terminal and the device communicating with each other wirelessly. The audio device is equipped with inertial sensors and with a binaural rendering engine. The portable computer terminal comprises software that generates guiding-instruction data associating a description of an audio signal to be delivered, and an indication relative to the virtual position of this audio signal. The binaural rendering engine generates a spatialized audio signal, which is delivered to the user by the audio device, depending on the guiding-instruction data, transmitted by the portable computer terminal via wireless communication, and on data of the inertial sensors.

### CROSS-REFERENCES TO RELATED APPLICATIONS

This application is a national phase of International Patent Application No. PCT/EP2022/078572, filed on Oct. 13, 2022, which claims the benefit of French Patent Application No. 2 110 987, filed on Oct. 15, 2021, the entire disclosures of which are incorporated herein by way of reference.

### FIELD OF THE INVENTION

The present invention relates to the field of guiding systems, making it possible to ensure the guiding of a user moving along a route.

In particular, the present invention relates to such guiding devices wherein the indications allowing the user to be guided are communicated to that person exclusively or not exclusively by audio signals.

The invention also relates to a guiding method for effectively guiding a user using audio signals.

### BACKGROUND OF THE INVENTION

Many guiding systems are known for guiding users. Some of these guiding systems are specifically adapted to guiding a user moving in a vehicle. These guiding systems then provide the user with indications on the directions to be taken, in particular at each intersection. These indications are communicated to the user in a visual form, for example by means of a display, and in an audio form, by delivering a synthesized or pre-recorded voice giving the user steering indications.

These guiding systems have proven to not very practical for users to use, in particular for those moving on foot. Indeed, a user moving on foot, or using vehicles such as a bicycle or a scooter, cannot easily consult a screen providing visual guiding indications. Furthermore, existing guiding systems do not allow the user's position, nor their orientation, to be taken into account in a sufficiently precise manner to allow a pedestrian to be guided.

Finally, voice-based audio guiding indications also require sustained user attention, and are not always sufficiently intuitive to allow effective guiding, especially when they are not complemented by the visual indications of a screen.

It has been devised to guide users, in particular pedestrians, by delivering to them, via earphones, stereophonic sound located virtually in the direction towards which the user is to be guided.

Such guiding systems can for example be implemented using augmented reality headsets, which are complex equipment requiring a substantial connection with powerful computing hardware.

Wireless earphones, connected to computer terminals by radio networks, often according to the Bluetooth standard, have been available for several years. Some of these wireless earphones have inertial sensors, such as accelerometers, gyroscopes or inertial platforms, for example, enabling them to detect and measure the position or movements of the wearing user's head. Such earphones can thus generate binauralized sounds, which are virtually located in a physical direction defined very precisely, independently of the position of the user's head.

The document US 10 598 506 B2 thus proposes a guiding system wherein such wireless earphones would comprise both equipment for measuring the position of the user's head, a guiding system defining a direction of guidance towards which the user is directed and a binaural rendering engine enabling the generating of a sound located virtually in this direction of guidance, taking into account the position of the user's head.

Such a solution, although apparently effective, has not been proposed on the market. Indeed, it requires the use of wireless earphones with very large computer processing capacities, greater than the capacities of the equipment currently on the market, to simultaneously ensure the operation of the guiding system and the generating of a binauralized sound. It also requires that such wireless earphones comprise geolocation devices or receive geolocation data from an associated equipment. Such geolocation devices are relatively expensive components consuming a relatively large amount of energy. Their integration into wireless earphones would therefore represent an increase in the cost thereof and a reduction in their battery life.

Finally, in order to ensure the effective guiding of a user, and in particular to keep the information at that person's disposal on the locations they visit, it is necessary for the guiding system to have a continuous or quasi-continuous connection with the remote networks, for example with the Internet. Here again, integrating components enabling such a connection into wireless earphones leads to an increase in their cost, required processing power, volume, and energy consumption. Consequently, earphones are generally not equipped with such connection capabilities.

In patent application US 2020/0264006 A1, another solution was conceived for guiding a user by binaural sound wherein the binaural rendering engine is placed in a portable terminal carried by the user, such as a cell phone, which is connected by a Bluetooth-style link with the wireless earphones. This terminal can then receive information relating to the position of the user's head, which are sent to that person by the wireless earphones. This information is used by the binaural rendering engine to generate a plurality of sound channels, taking into account the position of the head. These sound channels are sent by the terminal to the earphones by the Bluetooth connection.

This solution has the major disadvantage of generating significant latency in the reaction to the movements of the user's head. Thus, when such a movement is detected, a certain length of time is required for the corresponding information to be sent by the earphones to the associated terminal, and then for the associated terminal to generate the binauralized sound. In addition, the sending of this binauralized sound by the terminal to the earphones via the Bluetooth communication channels can generate relatively significant latency in the receiving these data by the user. In such cases, sometimes, when the user is moving their head, the change in orientation of the sound that they are listening to adapts to this movement with a lag of several hundred milliseconds, which produces a troublesome inconsistency. Such latency makes using the guiding solution uncomfortable, or even impossible, in situations involving rapid movements of the user.

The present invention aims to overcome these disadvantages of the prior art.

In particular, the present invention aims to provide the user with a guiding system composed of a portable terminal and an audio device capable of communicating with one another by a wireless link, which is more effective than the guiding devices of the prior art.

It has in particular an objective of proposing to the user such a guiding system, wherein the latency between a movement of the user and the adaptation of the guidance to this movement is reduced.

Yet another particular objective of the invention is to propose to the user such a guiding system wherein the guiding information can be regularly updated.

Another objective of the invention is to provide such a device that can be implemented with standard hardware components, whose cost, energy consumption and volume remain reasonable.

### DISCLOSURE OF THE INVENTION

These objectives, as well as others which will appear more clearly subsequently, are achieved by means of a system for guiding a user, which comprises a portable computer terminal intended to be transported by the user, a stereophonic audio device, intended to be associated with the user's head, to deliver a different sound to each of their ears, the portable computer terminal and the audio device communicating with each other via a wireless communication link, the audio device being equipped with inertial sensors able to measure the position and/or movements of the audio device, and a binaural rendering engine receiving the data from these inertial sensors. According to the invention, the portable computer terminal comprises software capable of generating guiding-instruction data associating a description of at least one audio signal to be delivered and an indication relative to the virtual position of the audio signal(s) to be delivered, and the binaural rendering engine is able to generate a spatialized audio signal, which is delivered to each of the user's ears by the audio device, the spatialized audio signal being generated depending on the guiding-instruction data, transmitted by the portable computer terminal via the wireless communication link, and on data from the inertial sensors.

The audio system according to the invention thus makes it possible to generate a guiding of the user by a binaural sound, taking into account the position of the user's head and movements. The distribution of this system between the portable computer terminal and the stereophonic audio device makes it possible to ensure effective guiding without requiring exceptional performance of the components implemented. In particular, the sending to the audio device, by the portable computer terminal, of the description of the audio signal to be delivered makes it possible to ensure a fluid wireless communication, without latency, between the portable computer terminal and the audio device. Indeed, such a description of the audio signal to be delivered is much smaller in size than an audio file.

Preferably, the audio device consists of a pair of wireless earphones, each of the earphones being able to deliver a sound to one of the user's ears.

Such earphones are easily connected by a Bluetooth-type link to a portable computer terminal. Moreover, they commonly comprise inertial sensors.

Advantageously, the portable computer terminal comprises software capable of computing a route based on location information, and on a destination.

According to a preferred embodiment, the portable computer terminal comprises a positioning data receiver.

According to another possible embodiment, the audio device comprises a positioning data receiver.

According to an advantageous embodiment, the indication relating to the virtual position of the audio signal(s) to be delivered is defined relative to the position of the audio device.

According to another advantageous embodiment, the indication relating to the virtual position of the audio signal(s) to be delivered is defined by a geographical position that does not take into account the position of the audio device.

Advantageously, the portable computer terminal consists of a cell phone.

A cell phone has the advantage of offering the guiding system numerous possibilities for connecting to networks.

According to an advantageous embodiment, the guiding-instruction data associates a description of at least two distinct audio signals to be delivered, and an indication relating to the virtual position of each of the audio signals to be delivered.

The guiding system can thus, for example, simultaneously deliver a binaural guiding sound, which must be monitored by the user, and another binaural sound, virtually located at another position, which indicates to the user an element of their environment, such as a hazard, an obstacle, a point of interest, etc.

The invention also relates to a method for guiding a user using a guiding system as described above, this method comprising the following steps:
a step of generating, by software implemented on the portable computer terminal, guiding-instruction data that associates a description of at least one audio signal to be delivered and an indication relating to the virtual position of the audio signal(s) to be delivered,
a step of transmitting the guide-instruction data to the audio device, via the wireless communication link,
a step of generating, by the binaural rendering engine, a spatialized audio signal, depending on the guiding-instruction data and data from the inertial sensors, and
a step of delivering the spatialized audio signal to the user, by the audio device.

### LIST OF FIGURES

The invention will be better understood upon reading the following description of preferential embodiments, given by way of a simple figurative, non-limiting example, and accompanied by the figures, in which:

FIG. 1 is a schematic representation of a guiding system according to one embodiment of the invention;

FIG. 2 is a diagram schematically representing the components allowing the operation of the guiding system of FIG. 1.

### DETAILED DESCRIPTION OF EMBODIMENTS OF THE INVENTION

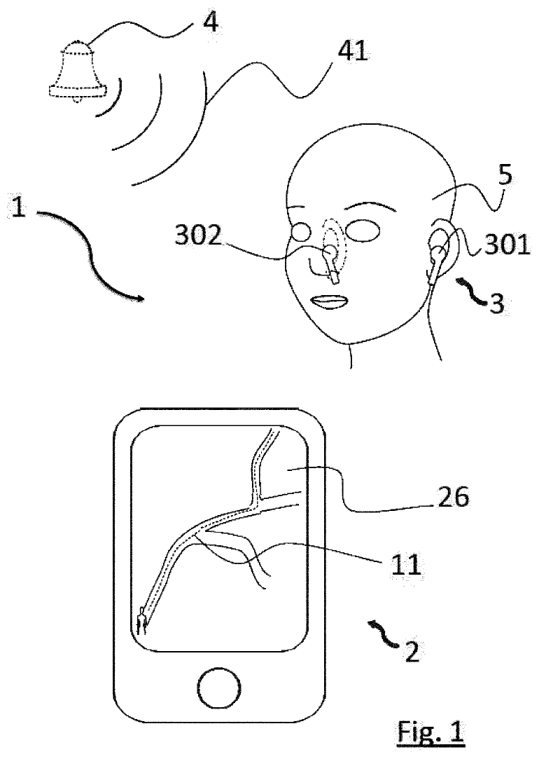

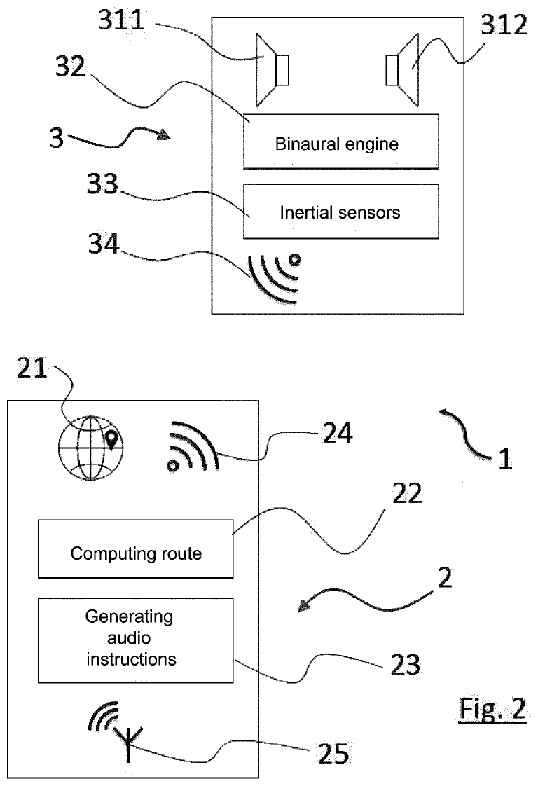

FIGS. 1 and 2 schematically depict a guiding system 1 according to one embodiment of the invention. This guiding system 1 advantageously comprises a portable computer terminal 2 and a stereophonic audio device 3.

The portable terminal 2 is an electronic device such as a cell phone, a tablet, or a navigation assistant. In the embodiment represented by FIGS. 1 and 2, it comprises, in a known manner, a positioning data receiver 21 enabling it to determine its geolocation. Such a geolocation data receiver may for example be a receiver of a geolocation system such as those known under the name “GPS” (acronym for “Global Positioning System”), “Galileo” or “GLONASS”.

This portable terminal 2 also comprises a route computer able to calculate a route taking into account in particular the position of the portable terminal 2, determined by the positioning data receiver 21, and destination data, provided for example by the user. In the embodiment shown, this route calculator is route computing software 22 operating on the portable terminal 2. It is also possible, in other embodiments, that the route calculation is carried out on software operating on a remote server, which determines the route depending on the position of the portable terminal 2 and on destination data, and which sends the route to the portable terminal 2.

The portable terminal 2 is intended to be carried continuously by the user 5 of the guiding system 1. It may conventionally comprise a screen 26 able to display map data and a route 11 and interfaces, for example touch-sensitive interfaces, making it possible to receive instructions from the user. However, the guiding system 1 is designed to be used by the user 5 without the user having to visually consult the portable terminal 2 during the guiding.

The guiding system 1 also comprises an audio device 3 which, in the embodiment shown, consists of two earphones 301 and 302, each placed in an ear of the user 5. These two earphones 301 and 302 are in wireless communication with each other, such that they can function as a single stereophonic audio device. According to the invention, this audio device 3 is, in the context of the guiding system 1, in wireless communication with the portable computer terminal 2.

In other possible embodiments of the invention, the audio device 3 may for example be an audio headset comprising two earphones, or a virtual reality or augmented reality headset comprising two earphones. According to the invention, it is important that the audio device 3 has a distinct sound transmitter for each user's ear. Thus, this audio device 3 makes it possible to deliver to the user a spatialized or binauralized audio signal, that is to say an audio signal that virtually seems to come from a position precisely identifiable by the user in a three-dimensional frame of reference.

According to the invention, the audio device 3 comprises at least one inertial sensor giving information on the position of the user's head, or on the modifications of this position. Such inertial sensors, known per se, may in particular comprise accelerometers, an inertial platform, gyroscopes, etc. Such inertial sensors advantageously make it possible for the audio device 3 to have information concerning the position and motions of the user's head, relative to the environment wherein they are moving around.

It is known to adapt or generate a stereophonic audio signal, based on such information on the position or movements of the user's head, so that a stereophonic audio device can deliver to the user a sound originating, virtually, from a precise position of their environment, regardless of the position or motions of their head. Such an adaptation of a stereophonic sound, allowing the determination of the distinct sound tracks to be delivered in each of the two ears of the user depending on the position of his head, so that the sound seems to come from a determined point in space, can be carried out by an audio signal synthesis software, which can be called a “binaural rendering engine” or “spatializer”.

The guiding system 1 according to the invention ensures the guiding of the user 5 along a route, by delivering to the user 5, via the audio device 3, an audio signal 41 which virtually originates from a position 4 of the space wherein the user 5 is progressing, independently of the position of the head thereof. The user 5 can thus follow the instructions of the guiding system 1 simply and intuitively, for example by heading in the direction from which the audio signal 41 is meant to be coming.

In some preferential embodiments, the virtual position 4, from which the audio signal 41 seems to be coming, can move, along the route to be followed, at the same time as the user 5. Thus, the user 5 can travel the route while being constantly directed toward this audio signal 41 which seems to come from a point situated a few meters ahead, as if they were following the source of this sound moving along the route. Such a guiding method is particularly advantageous for guiding a person moving, for example, on foot or on a bike, who can thus be guided effectively and intuitively without having to follow any visual indication that might divert their attention.

FIG. 2 is a diagram schematically representing the portable terminal 2 and the audio device 3 composing the guiding system 1 according to one embodiment of the invention, and the distribution in these two devices of hardware and software components making it possible to ensure the guiding of the user.

In this embodiment, the audio device 3 comprises inertial sensors 33, a binaural rendering engine 32, a radio communication equipment 34 and the sound transmitters 311 and 312, which can be placed respectively in the two earphones 301 and 302.

The terminal 2 comprises a positioning data receiver 21, a route computing software 22, software for generating audio instructions 23 and radio communication equipment 24. It also advantageously comprises a device for communication with a remote network 25, and input/output interfaces such as the screen 26, which can be a touch screen.

The radio communication equipment 24 of the terminal 2 and the radio communication equipment 34 of the audio device 3 allow the terminal 2 and the audio device 3 to communicate with each other. In a known manner, these radio communication equipment 24 and 34 communicate according to one of the communication standards known as “Bluetooth”, which is very suitable for interactions between electronic equipment close to one another.

In a known manner, these “Bluetooth” standards allow data communications that are distributed between multiple communication channels. Some of these communication channels are intended specifically to communicate information of the audio type, such as tracks containing high-definition coded sounds, whereas other communication channels allow the transfer of non-audio data, such as instructions. It is known, in the use of such communications according to Bluetooth standards, that the transfer of audio tracks coded in high definition can lead to a time shift in the transmission of the audio data.

To perform a guiding of the user, the guiding system 1 according to the embodiment represented by FIG. 2 must obtain user-given route parameters, comprising in particular destination instructions. Such parameters can be obtained, for example, via input/output interfaces of the terminal 2, or by voice recognition of data given verbally by the user, and captured by a microphone of the audio device 3 or of the terminal 2.

Depending on these parameters, the route computing software 22 can determine, in a known manner, a route taking into account the current position of the terminal 2, which is known to the positioning data receiver 21, and ranging from this current position to the determined destination. This route computing software 22 can be a computer designed or specifically configured for the guiding system 1, or may consist of any type of known route computer, adapted to determine an outdoor route, or an indoor one, etc.

It should be noted that, according to one variant of the embodiment shown, the route computing software can operate on a remote server, rather than on the terminal 2. In this case, the terminal 2 sends to this remote server the parameters making it possible to determine the route, comprising in particular the geolocation information of the terminal 2, via the communication equipment with a remote network 25, and by the same means, receives the route data.

Depending on the route calculated, the software for generating audio instructions 23 can determine guiding-instruction data, which describe an audio signal to be delivered to the user to guide them. These guiding-instructions data comprise, according to the invention, a description of an audio signal to be delivered, and an indication relating to the virtual position of this audio signal to be delivered.

The description of an audio signal indicates what sound should be delivered. This description may for example consist of the designation of a sound file to be delivered, this sound file preferably being stored in the audio device 3. This description may also consist of a file describing a sound. This file may for example be a description of its recorded sound in a format known as “MIDI” (an acronym for “Musical Instrument Digital Interface”) or any other equivalent sound description format. It is also possible that this sound description contains a text, which is intended to be interpreted by a voice synthesis software pronouncing this sound. The description of the audio signal can also comprise indications on the way in which a sound is to be delivered, for example continuously or discontinuously, repeated a certain number of times, with a delay between the repetitions, sliding toward the treble or the bass, etc.

Unlike sound files comprising high-definition sounds, a sound description file has a very small size, and can be sent very quickly, with a very low latency. Specifically, sound files generally have a much larger size than 64 KB per second of sound, usually between 128 KB per second and 256 KB per second. On the contrary, sound description files may be less than a few KB per second of sound. Preferably, for the implementation of the present invention, they have a volume less than 50 KB per second of sound, and even more preferentially less than 20 KB per second of sound.

According to the invention, the guiding-instruction data also comprises an indication relating to the virtual position of the audio signal to be delivered. This position of the audio signal to be delivered may for example be, in the embodiment shown, given as a transmission position of the audio signal relative to the geographical location of the terminal 2, which is determined by the positioning data receiver 21. Thus, this audio position information, which can be a position in space, may for example consist of data representative of the azimuth in the direction of which the sound must be understood, relative to a fixed direction such as geographic North, and optionally an item of data representative of the distance to which the sound is to be heard as well as an item of data representative of the height at which the sound is to be heard.

These data representative of the virtual transmission position of the audio signal are associated with the description data of the audio signal by the program for generating the guiding instructions, to form the guiding-instruction data.

These guiding-instruction data are sent by the radio communication equipment 24 of the terminal 2 to the radio communication equipment 34 of the audio device 3, via a radio communication that can be in a format such as Bluetooth format.

It should be noted that this communication is not done in the form of sending of audio tracks, sent to the communication channels of the Bluetooth format which are specifically dedicated to transfers of audio tracks. Indeed, the guiding-instruction data generated by the terminal 2 have a data volume much smaller than the data volume of a high-definition audio file. These guiding-instruction data can therefore be sent via the channels provided by the Bluetooth standard for the transfer of data other than audio data. Because of their small data volume, they can be transmitted without generating excessive latency.

When the audio device 3 receives this guiding-instruction data, via its radio communication equipment 34, these guiding-instruction data are sent to the binaural rendering engine 32. This binaural rendering engine 32 is software which, in a known manner, is able to modify or create a stereophonic sound track such that it seems to be located at a chosen position, relative to the user listening to these sounds. This binaural rendering engine 32 can thus generate a sound corresponding to the description of the audio signal, contained in the guiding-instruction data, and can distribute this sound between the channels of a stereophonic sound, taking into account on the one hand indications concerning the position of the sound to be delivered, contained in the guiding-instruction data, and on the other hand information concerning the orientation of the user's head, provided by the inertial sensors 33.

Each of the stereophonic sound channels can then be sent by the binaural rendering engine 32 to one of the sound transmitters 311 and 312, to be delivered in one of the two ears of the user. The user can thus hear the audio signal 41 generated by the binaural rendering engine 32 as though they were originating from the position 4 in the space. That person can then be easily guided in their movements, for example by heading toward this virtual position 4.

In the embodiment described above, the audio device 3 comprises a single binaural rendering engine 32, in one of the earphones. It is however possible, in a variant of this embodiment, for each of the earphones 301 and 302 to be equipped with a binaural rendering engine which generates only its path.

The guiding system thus makes it possible to ensure a guiding of the user by means of one or more sounds that seem to come from a precise location in space, independently of the position of the user's head. This guiding can be done with an audio device, for example consisting of wireless earphones, which only comprise limited features. Indeed, this audio device must comprise a binaural rendering engine and inertial sensors, but it is not necessary for it to comprise a positioning data receiver, route computing software, or communication equipment with a remote network, which are components requiring significant computing capabilities and heavily energy-consuming. Finally, this guiding requires only a small volume of radio communications between the portable terminal and the audio device. This small communication volume makes it possible to avoid latency that would be detrimental to the responsiveness of the guiding system, and even allows the audio device to receive data other than what is necessary for guiding.

It should be noted that, in an alternative embodiment, the audio device 3 may comprise a positioning data receiver. In this case, the terminal 2 can receive the information from this positioning data receiver, for example to determine the route. It is also possible, in this case, that the indications concerning the position of the sound to be delivered, included in the guiding-instruction data, are in the form of geographical coordinates of the position from which the sound must seem to be transmitted. The binaural rendering engine 32 can then generate the binauralized sound by taking into account the information of the positioning data receiver.

According to another possible embodiment of the invention, the audio device 3 can also communicate with the terminal 2 information from the inertial sensors 33. In this case, the indication relating to the virtual position of the audio signal can be defined by taking into account the orientation of the user's head, and be given in relative position, relative to the user's head. However, such an embodiment is not the preferred embodiment for implementing the invention. Indeed, it increases the quantity of data to be transmitted between the terminal 2 and the audio device 3, and risks increasing the latency in the guiding of the user.

According to a variant of the embodiments described, the guiding-instruction data generated by the software for generating audio instructions 23 comprises the description of at least two distinct audio signals to be delivered simultaneously to the user, and an indication relating to the virtual position of each of these audio signals to be delivered. It is thus possible to deliver to the user, simultaneously, an audio signal allowing that person to be guided, for example the sound of a bell moving ahead of them, along the route to be followed, and sounds relating to points of interest situated around them. Such sounds may for example correspond to the audio branding of nearby shops, or sounds known to the user making it possible to indicate to them, for example, obstacles, hazards or points of interest.

In order for the software for generating audio instructions 23 to be able to generate such audio signals, it is particularly useful for the terminal 2 to comprise communication equipment with a remote network 25, as is usually the case for mobile telephones. Indeed, thanks to this communication equipment with a remote network 25, the terminal 2 can very easily obtain recent information on obstacles, hazards or points of interest surrounding the user, via networks such as the Internet.

It should be noted that each of the audio signals delivered to the user by the guiding system 1 according to the invention can be delivered continuously or discontinuously. For example, a guiding signal to be monitored by the user can be delivered continuously, so that it is easier to follow. It is also possible, to be less bothersome to the user, for this signal to be delivered discontinuously, for example at regular intervals when the user is moving in a straight line, and at closer intervals when the user is approaching an intersection or must change direction.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1.-10. (canceled)

11. A system for guiding a user, comprising:
a portable computer terminal configured to be transported by the user,
a stereophonic audio device configured to be associated with a head of the user and to deliver a distinct sound to each ear of the user,
said portable computer terminal and said audio device communicating with each other via a wireless communication link,
said audio device being equipped with:
inertial sensors configured to measure a position, or a motion, or both of said audio device, and
a binaural rendering engine configured for receiving data from said inertial sensors,
wherein said portable computer terminal comprises software configured to generate guiding-instruction data associating:
a description of at least one audio signal to be delivered,
an indication relative to a virtual position of said at least one audio signal to be delivered,
and wherein said binaural rendering engine is configured to generate a spatialized audio signal, delivered to each of the ears of said user by said audio device, said spatialized audio signal being generated depending on:
said guiding-instruction data, transmitted by said portable computer terminal via said wireless communication link, and
data from said inertial sensors.

12. The guiding system according to claim 11, wherein said audio device comprises of a pair of wireless earphones, each of said wireless earphones being able to delivered sound to one of the ears of said user.

13. The guiding system according to claim 11, wherein said portable computer terminal comprises software configured to compute a route depending on location information and on a destination.

14. The guiding system according to claim 11, wherein said portable computer terminal comprises a positioning data receiver.

15. The guiding system according to claim 11, wherein said audio device comprises a positioning data receiver.

16. The guiding system according to claim 15, wherein said indication relating to the virtual position of said at least one audio signal to be delivered is defined relative to the position of said audio device.

17. The guiding system according to claim 11, wherein said indication relating to the virtual position of said at least one audio signal to be delivered is defined by a geographical position that does not take into account the position of said audio device).

18. The guiding system according to claim 11, wherein said portable computer terminal comprises a cell phone.

19. The guiding system according to claim 11, wherein said guiding-instruction data associate:
a description of at least two distinct audio signals to be delivered,
an indication relating to the virtual positions of each of said two distinct audio signals to be delivered.

20. A method for guiding a user via the guiding system according to claim 11, said method comprises the following steps:
a step of generating, by the software implemented on the portable computer terminal, guiding-instruction data that associates the description of the at least one audio signal to be delivered and the indication relating to the virtual position of the at least one audio signal to be delivered,
a step of transmitting the guide-instruction data to said audio device, via the wireless communication link,
a step of generating, by said binaural rendering engine, the spatialized audio signal, depending on said guiding-instruction data and data from said inertial sensors, and
a step of delivering said spatialized audio signal to the user, by said audio device.
